(19) United States
(12) Patent Application Publication
(10) Pub. No.: US 2019/0010021 A1
(43) Pub. Date: Jan. 10, 2019

(54) ELEVATOR SENSOR SYSTEM CALIBRATION

(71) Applicant: Otis Elevator Company, Farmington, CT (US)

(72) Inventors: Soumalya Sarkar, Manchester, CT (US); Teems E. Lovett, Glastonbury, CT (US); George S. Ekladious, Glastonbury, CT (US)

(21) Appl. No.: 15/642,477

(22) Filed: Jul. 6, 2017

(51) Int. Cl. B66B 5/00

(52) U.S. Cl. CPC B66B 5/0025

(57) ABSTRACT

According to an aspect, a method of elevator sensor system calibration includes collecting, by a computing system, a plurality of baseline sensor data from one or more sensors of an elevator sensor system as a field-site baseline response. The computing system compares the field-site baseline response to an experiment-site baseline response. The computing system performs analytics model calibration to produce a calibrated trained model for fault diagnostics and/or prognostics based on one or more response changes between the field-site baseline response and the experiment-site baseline response.

### BACKGROUND

The subject matter disclosed herein generally relates to elevator systems and, more particularly, to sensor system calibration.

An elevator system can include various sensors to detect the current state of system components and fault conditions. To perform certain types of fault or degradation detection, precise sensor system calibration may be needed. Sensor systems as manufactured and installed can have some degree of variation. Sensor system responses can vary compared to an ideal system due to these sensor system differences and installation differences, such as elevator component characteristic variations in weight, structural features, and other installation effects.

### BRIEF SUMMARY

According to some embodiments, a method of elevator sensor system calibration is provided. The method includes collecting, by a computing system, a plurality of baseline sensor data from one or more sensors of an elevator sensor system as a field-site baseline response. The computing system compares the field-site baseline response to an experiment-site baseline response. The computing system performs analytics model calibration to produce a calibrated trained model for fault diagnostics and/or prognostics based on one or more response changes between the field-site baseline response and the experiment-site baseline response.

In addition to one or more of the features described above or below, or as an alternative, further embodiments may include where the calibrated trained model is trained by performing a plurality of experiments on a different instance of the elevator sensor system, including an experiment baseline that generates the experiment-site baseline response.

In addition to one or more of the features described above or below, or as an alternative, further embodiments may include where performing analytics model calibration includes applying transfer learning to determine a transfer function based on the one or more response changes.

In addition to one or more of the features described above or below, or as an alternative, further embodiments may include where a baseline designation of the calibrated trained model is shifted according to the transfer function.

In addition to one or more of the features described above or below, or as an alternative, further embodiments may include where transfer learning shifts at least one trained classification model.

In addition to one or more of the features described above or below, or as an alternative, further embodiments may include where transfer learning shifts at least one trained regression model.

In addition to one or more of the features described above or below, or as an alternative, further embodiments may include where transfer learning shifts at least one trained fault detection model, and a fault designation comprises one or more of: a roller fault, a track fault, a sill fault, a door lock fault, a belt tension fault, a car door fault, and a hall door fault.

In addition to one or more of the features described above or below, or as an alternative, further embodiments may include where collection of the baseline sensor data is performed responsive to a calibration mode request.

In addition to one or more of the features described above or below, or as an alternative, further embodiments may include where collection of the baseline sensor data is performed during normal operation of an elevator door.

In addition to one or more of the features described above or below, or as an alternative, further embodiments may include where the baseline sensor data is collected at two or more different landings of an elevator system.

According to some embodiments, an elevator sensor system is provided. The elevator sensor system includes one or more sensors operable to monitor an elevator system. The elevator sensor system also includes a computing system including a memory and a processor that collects a plurality of baseline sensor data from the one or more sensors as a field-site baseline response, compares the field-site baseline response to an experiment-site baseline response, and performs analytics model calibration to produce a calibrated trained model for fault diagnostics and/or prognostics based on one or more response changes between the field-site baseline response and the experiment-site baseline response.

Technical effects of embodiments of the present disclosure include elevator sensor system calibration using transfer learning to produce a calibrated trained model and to improve fault detection and classification accuracy based on differences between an experiment-site baseline response and a field-site baseline response.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 is a schematic illustration of an elevator door assembly in accordance with an embodiment of the present disclosure;

FIG. 3 is a process of transfer learning for calibration in accordance with an embodiment of the present disclosure;

FIG. 4 is a process for analytics model calibration in accordance with an embodiment of the present disclosure;

FIG. 5 is a schematic block diagram illustrating a computing system that may be configured for one or more embodiments of the present disclosure; and

FIG. 6 is a process for elevator sensor system calibration in accordance with an embodiment of the present disclosure.

### DETAILED DESCRIPTION

A detailed description of one or more embodiments of the disclosed apparatus and method are presented herein by way of exemplification and not limitation with reference to the Figures.

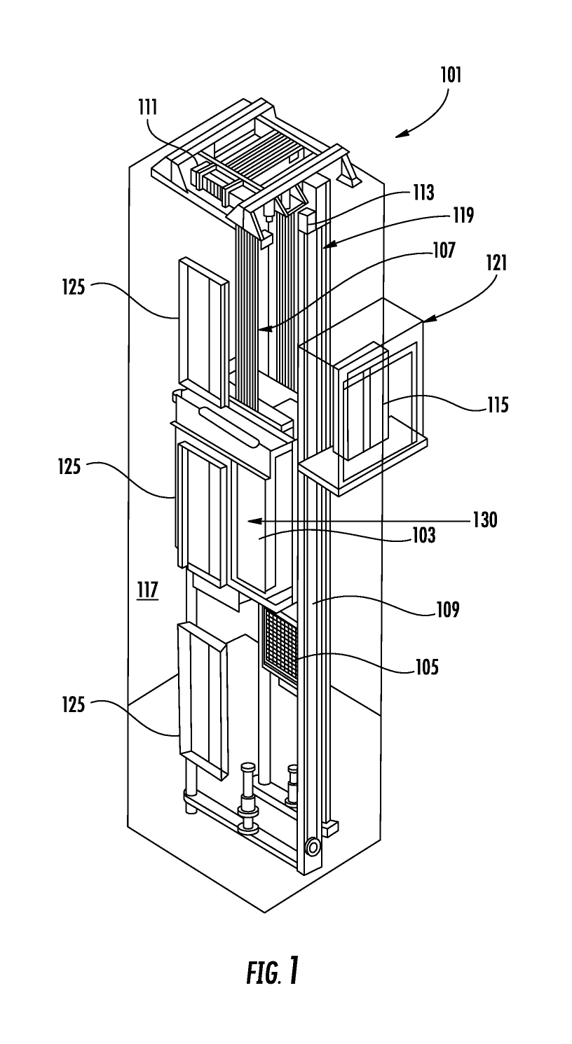

FIG. 1 is a perspective view of an elevator system 101 including an elevator car 103, a counterweight 105, one or more load bearing members 107, a guide rail 109, a machine 111, a position encoder 113, and an elevator controller 115. The elevator car 103 and counterweight 105 are connected to each other by the load bearing members 107. The load bearing members 107 may be, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The load bearing members 107 engage the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The elevator controller 115 is located, as shown, in a controller room 121 of the elevator shaft 117 and is configured to control the operation of the elevator system 101, and particularly the elevator car 103. For example, the elevator controller 115 may provide drive signals to the machine 111 to control the acceleration, deceleration, leveling, stopping, etc. of the elevator car 103. The elevator controller 115 may also be configured to receive position signals from the position encoder 113. When moving up or down within the elevator shaft 117 along guide rail 109, the elevator car 103 may stop at one or more landings 125 as controlled by the elevator controller 115. Although shown in a controller room 121, those of skill in the art will appreciate that the elevator controller 115 can be located and/or configured in other locations or positions within the elevator system 101. In some embodiments, the elevator controller 115 can be configured to control features within the elevator car 103, including, but not limited to, lighting, display screens, music, spoken audio words, etc.

The machine 111 may include a motor or similar driving mechanism and an optional braking system. In accordance with embodiments of the disclosure, the machine 111 is configured to include an electrically driven motor. The power supply for the motor may be any power source, including a power grid, which, in combination with other components, is supplied to the motor. Although shown and described with a rope-based load bearing system, elevator systems that employ other methods and mechanisms of moving an elevator car within an elevator shaft, such as hydraulics or any other methods, may employ embodiments of the present disclosure. FIG. 1 is merely a non-limiting example presented for illustrative and explanatory purposes.

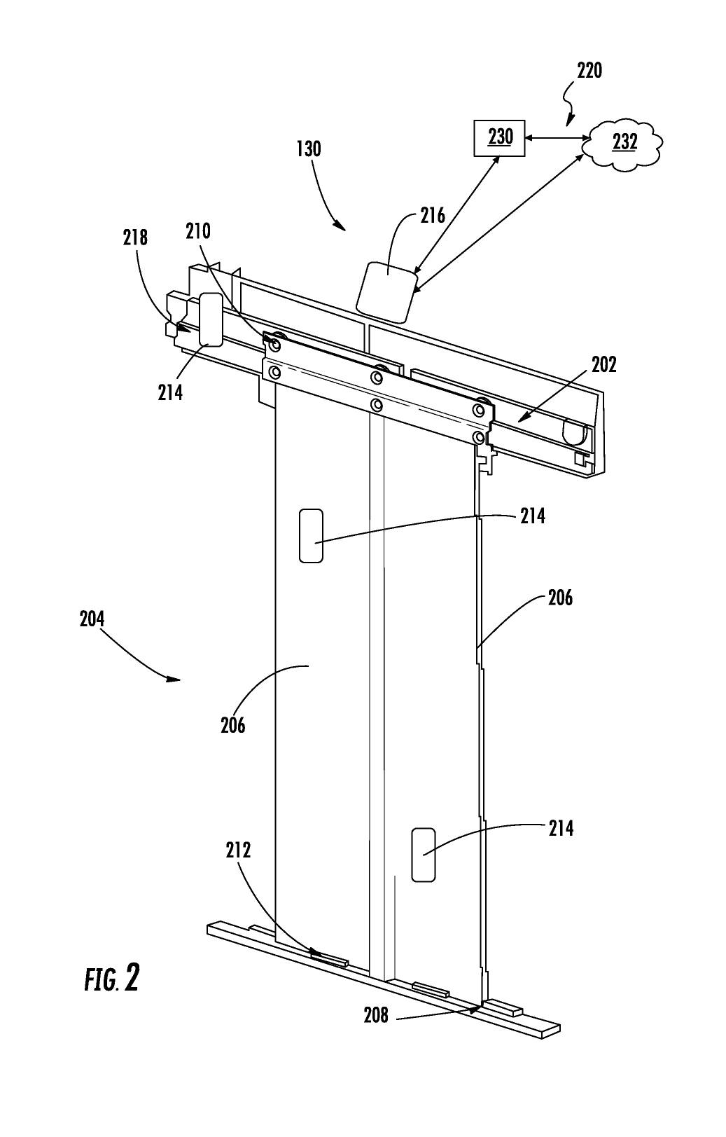

The elevator car 103 includes at least one elevator door assembly 130 operable to provide access between the each landing 125 and the interior (passenger portion) of the elevator car 103. FIG. 2 depicts the elevator door assembly 130 in greater detail. In the example of FIG. 2, the elevator door assembly 130 includes a door motion guidance track 202 on a header 218, an elevator door 204 including multiple elevator door panels 206 in a center-open configuration, and a sill 208. The elevator door panels 206 are hung on the door motion guidance track 202 by rollers 210 to guide horizontal motion in combination with a gib 212 in the sill 208. Other configurations, such as a side-open door configuration, are contemplated. One or more sensors 214 are incorporated in the elevator door assembly 130 and are operable to monitor the elevator door 204. For example, one or more sensors 214 can be mounted on or within the one or more elevator door panels 206 and/or on the header 218. In some embodiments, motion of the elevator door panels 206 is controlled by an elevator door controller 216, which can be in communication with the elevator controller 115 of FIG. 1. In other embodiments, the functionality of the elevator door controller 216 is incorporated in the elevator controller 115 or elsewhere within the elevator system 101 of FIG. 1. Further, calibration processing as described herein can be performed by any combination of the elevator controller 115, elevator door controller 216, a service tool 230 (e.g., a local processing resource), and/or cloud computing resources 232 (e.g., remote processing resources). The sensors 214 and one or more of: the elevator controller 115, the elevator door controller 216, the service tool 230, and/or the cloud computing resources 232 can be collectively referred to as an elevator sensor system 220.

The sensors 214 can be any type of motion, position, acoustic, or force sensor, such as an accelerometer, a velocity sensor, a position sensor, a microphone, a force sensor, or other such sensors known in the art. The elevator door controller 216 can collect data from the sensors 214 for control and/or diagnostic/prognostic uses. For example, when embodied as accelerometers, acceleration data (e.g., indicative of vibrations) from the sensors 214 can be analyzed for spectral content indicative of an impact event, component degradation, or a failure condition. Data gathered from different physical locations of the sensors 214 can be used to further isolate a physical location of a degradation condition or fault depending, for example, on the distribution of energy detected by each of the sensors 214. In some embodiments, disturbances associated with the door motion guidance track 202 can be manifested as vibrations on a horizontal axis (e.g., direction of door travel when opening and closing) and/or on a vertical axis (e.g., up and down motion of rollers 210 bouncing on the door motion guidance track 202). Disturbances associated with the sill 208 can be manifested as vibrations on the horizontal axis and/or on a depth axis (e.g., in and out movement between the interior of the elevator car 103 and an adjacent landing 125.

Embodiments are not limited to elevator door systems but can include any elevator sensor system within the elevator system 101 of FIG. 1. For example, sensors 214 can be used in one or more elevator subsystems for monitoring elevator motion, door motion, position referencing, leveling, environmental conditions, and/or other detectable conditions of the elevator system 101.

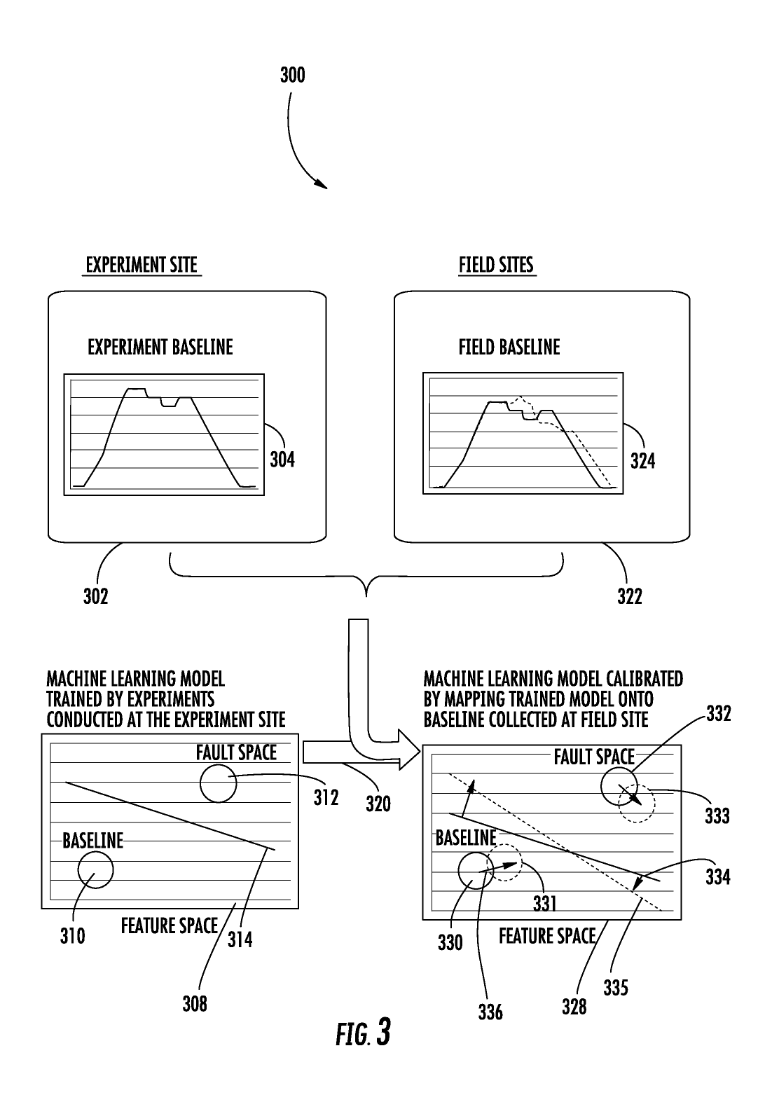

FIG. 3 depicts a transfer learning process 300 according to an embodiment. At an experiment site 302, experiments are performed including an experiment baseline that generates an experiment-site baseline response 304 observed while cycling an instance of the elevator door 204 of FIG. 2 between an open and a closed position and/or between a closed and open position. Baseline sensor data is collected by instances of the sensors 214 of the elevator sensor system 220 of FIG. 2 at the experiment site 302. The experiment-site baseline response 304 can be gathered as time domain data and converted into frequency domain and/or feature data using, for example, one or more wavelet transforms to characterize features of a nominal, non-faulty response observed while the elevator door 204 transitions between an open and closed position and/or between a closed and open position.

Multiple experiments performed at the experiment site 302 can be used to construct a feature space 308 of a trained model that establishes a baseline designation 310, a fault designation 312, and one or more fault detection boundaries 314. The feature space 308 can be used to extract and classify various features. For example, the baseline designation 310 in the feature space 308 can establish a nominal expected response to cycling of the elevator door 204 in a horizontal motion between an open and closed position and/or between a closed and open position. The baseline designation 310 may represent expected frequency response characteristics of an instance of the elevator door assembly 130 of FIG. 1 at the experiment site 302 for a non-faulty configuration. Various faults can be induced in the elevator door assembly 130 at the experiment site 302 that may not be readily producible in the field without damage. For instance, the elevator door assembly 130 at the experiment site 302 can be operated using a faulty version of the door motion guidance track 202 of FIG. 2, a faulty version of rollers 210 of FIG. 2, a faulty version of sill 208 of FIG. 2 and/or gib 212 of FIG. 2. Various levels of faulty components can be used to establish the fault designation 312 (e.g., lesser or greater degrees of component degradation/damage). The one or more fault detection boundaries 314 can be used to establish boundaries or regions within the feature space 308 of a likelihood of a fault/no-fault condition and/or for trending to observe response shifts headed from the baseline designation 310 towards the fault designation 312, e.g., a progressive degraded response. The experiment site 302 can be a test lab or a field location known to have one or more components in a faulty/degraded condition. For instance, the experiment site 302 in a lab or field location can have known correctly working components and known worn/broken components to use for baseline development and model training.

To calibrate instances of the elevator sensor system 220 of FIG. 2 at one or more field sites 322, a field baseline motion is commanded that cycles an instance of the elevator door 204 of FIG. 2 between an open and a closed position and/or between a closed and open position to produce a field-site baseline response 324. The field-site baseline response 324 is observed as baseline sensor data is collected by instances of the sensors 214 of the elevator sensor system 220 of FIG. 2 at each of the field sites 322. The field-site baseline response 324 can be captured as or adjusted to a format corresponding to the experiment-site baseline response 304. For example, the field-site baseline response 324 can be gathered as time domain data and converted into frequency domain and/or feature data using, for example, one or more wavelet transforms to characterize features of a nominal, non-faulty response observed while the elevator door 204 transitions between an open and closed position and/or a closed to open position.

The experiment-site baseline response 304 from the experiment site 302 is transferred 320 to the field sites 322 for comparison with the field-site baseline response 324 to map a trained model onto baseline data collected at the field sites 322. A feature space 328 at the field sites 322 can initially be equivalent to a copy of the feature space 308 of a trained model that establishes a baseline designation 330 equivalent to baseline designation 310, a fault designation 332 equivalent to fault designation 312, and one or more fault detection boundaries 334 equivalent to fault detection boundaries 314.

In embodiments, transfer learning can be used for trained model calibration at field sites 322 based on the field-site baseline response 324. Differences between the experiment-site baseline response 304 at the experiment site 302 and the field-site baseline response 324 at field sites 322 are quantified to produce calibrated feature shifts in feature space 328 as analytics model calibrations. For example, baseline designation 330 can be shifted to account for response changes as a calibrated baseline designation 331. The shifting can be quantified as a transfer function 336 in multiple dimensions. Similarly, fault designation 332 can be shifted to account for response changes as a calibrated fault designation 333 according to transfer function 336. Further, one or more fault detection boundaries 334 can be shifted to account for response changes as one or more calibrated fault detection boundaries 335 according to transfer function 336. The transfer function 336 characterizes response differences between the experiment-site baseline response 304 and the field-site baseline response 324, for instance, as an output-to-input relationship defined with respect to dimensions of the feature space 328. Once the transfer function 336 is determined, the transfer function can be applied to other modeled features of the feature space 328 as an analytics model calibration. Transfer learning can shift at least one trained classification model, at least one trained regression model, and/or at least one trained fault detection model.

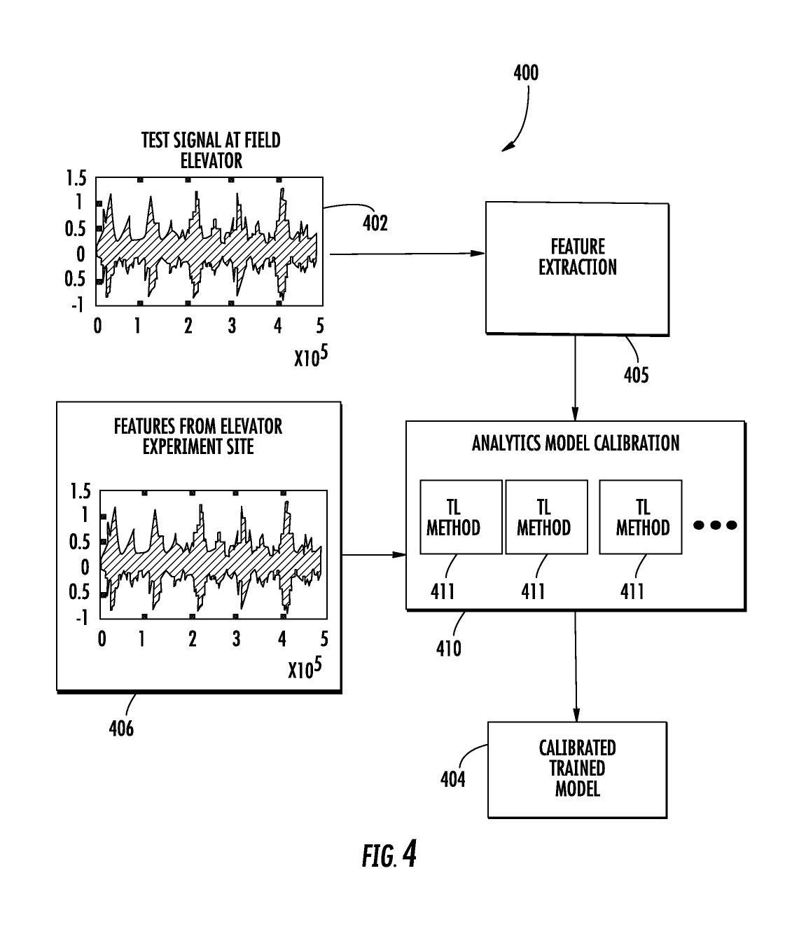

FIG. 4 depicts an analytics model calibration process 400 according to an embodiment. At one of the field sites 322 of FIG. 3, a computing system of the elevator sensor system 220 of FIG. 2 can receive sensor data 402 from one or more sensors 214 of FIG. 2 as a test signal (e.g., baseline sensor data). The sensor data 402 is an example of the field-site baseline response 324 of FIG. 3. The sensor data 402 can be collected while the elevator sensor system 220 of FIG. 2 is operating in a calibration mode responsive to a calibration mode request. In alternate embodiments, collection of the sensor data 402 is performed during normal operation of the elevator door 204 of FIG. 2. The sensor data 402 can be provided to feature extraction 405 to extract similar features as in features 406 extracted from experiment-site baseline response 304 of FIG. 3. As one example, the feature extraction 405 can apply a wavelet transform for feature extraction and analyze resulting field-site baseline features as part of analytics model calibration 410.

The analytics model calibration 410 can apply transfer learning to produce a calibrated trained model 404 based on one or more response changes determined between the field-site baseline response 324 of FIG. 3 (from sensor data 402) and the experiment-site baseline response 304 of FIG. 3 (reflected in features 406). One or more transfer learning methods 411 can be used depending on various factors. For example, transfer learning methods 411 performed by analytics model calibration 410 can apply baseline relative feature extraction, baseline affine mean shifting, similarity-based feature transfer, covariate shifting by kernel mean matching, and/or other transfer learning techniques known in the art. Characterization of sensor capability and processing capacity may result in selection of a particular instance of the transfer learning methods 411 using baseline relative feature extraction or baseline affine mean shifting if a smaller sized data set is available and/or processing resources are limited, using similarity-based feature transfer if a greater amount of processing capacity is available, and using covariate shifting by kernel mean matching if a larger sized data set is available. In some embodiments, multiple transfer learning methods 411 can be performed in parallel, with results compared/voted upon to select which method provides more consistent feature transfer results. Transfer learning performed in the analytics model calibration 410 can result in defining a transfer function 336 that characterizes a shift of the baseline designation 330 in the calibrated trained model 404 as calibrated baseline designation 331 of FIG. 3, shifts a fault designation 332 the calibrated trained model 404 as calibrated fault designation 333, and/or shifts at least one fault detection boundary 334 in the calibrated trained model 404 as calibrated fault detection boundary 335 of FIG. 3. The calibrated trained model 404 can be defined in terms of one or more model components, including but not limited to fault detection, fault classification and regression.

The shifting within the calibrated trained model 404 based on the analytics model calibration 410 can result in changes to feature definitions used by extraction and classification processes for normal diagnostic/prognostic monitoring operation, e.g., identifying extracted features as fault designations along with specific fault types such as a roller fault, a track fault, a sill fault, and the like. Further analysis can be performed for trending, prognostics, diagnostics, and the like based on classifications after calibration of the calibrated trained model 404.

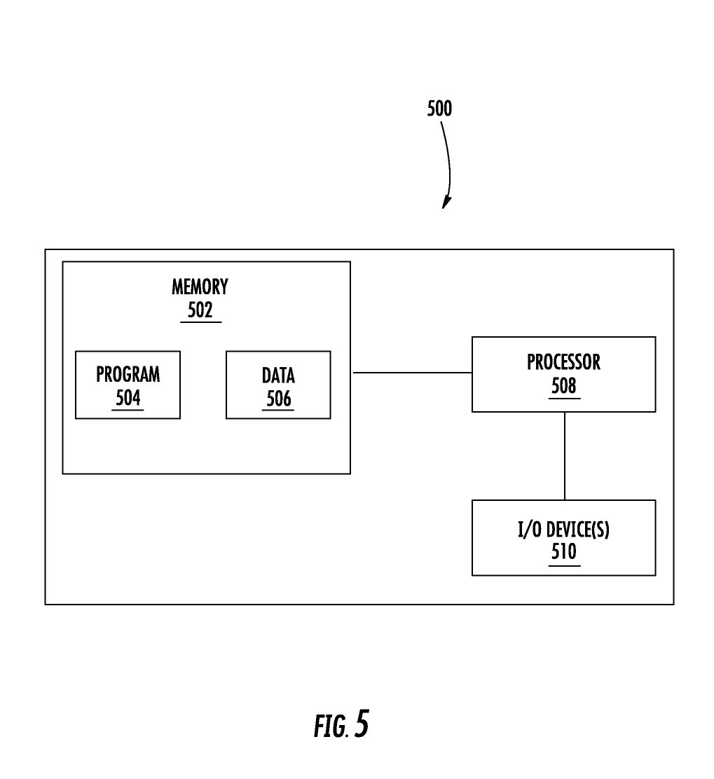

Referring now to FIG. 5, an exemplary computing system 500 that can be incorporated into elevator systems of the present disclosure is shown. The computing system 500 may be configured as part of and/or in communication with an elevator controller, e.g., controller 115 shown in FIG. 1, as part of the elevator door controller 216, service tool 230, and/or cloud computing resources 232 of FIG. 2 as described herein. When implemented as service tool 230, the computing system 500 can be a mobile device, tablet, laptop computer, or the like. When implemented as cloud computing resources 232, the computing system 500 can be located at or distributed between one or more network-accessible servers. The computing system 500 includes a memory 502 which can store executable instructions and/or data associated with control and/or diagnostic/prognostic systems of the elevator door 204 of FIG. 2. The executable instructions can be stored or organized in any manner and at any level of abstraction, such as in connection with one or more applications, processes, routines, procedures, methods, etc. As an example, at least a portion of the instructions are shown in FIG. 5 as being associated with a control program 504.

Further, as noted, the memory 502 may store data 506. The data 506 may include, but is not limited to, elevator car data, elevator modes of operation, commands, or any other type(s) of data as will be appreciated by those of skill in the art. The instructions stored in the memory 502 may be executed by one or more processors, such as a processor 508. The processor 508 may be operative on the data 506.

The processor 508, as shown, is coupled to one or more input/output (I/O) devices 510. In some embodiments, the I/O device(s) 510 may include one or more of a keyboard or keypad, a touchscreen or touch panel, a display screen, a microphone, a speaker, a mouse, a button, a remote control, a joystick, a printer, a telephone or mobile device (e.g., a smartphone), a sensor, etc. The I/O device(s) 510, in some embodiments, include communication components, such as broadband or wireless communication elements.

The components of the computing system 500 may be operably and/or communicably connected by one or more buses. The computing system 500 may further include other features or components as known in the art. For example, the computing system 500 may include one or more transceivers and/or devices configured to transmit and/or receive information or data from sources external to the computing system 500 (e.g., part of the I/O devices 510). For example, in some embodiments, the computing system 500 may be configured to receive information over a network (wired or wireless) or through a cable or wireless connection with one or more devices remote from the computing system 500 (e.g. direct connection to an elevator machine, etc.). The information received over the communication network can stored in the memory 502 (e.g., as data 506) and/or may be processed and/or employed by one or more programs or applications (e.g., program 504) and/or the processor 508.

The computing system 500 is one example of a computing system, controller, and/or control system that is used to execute and/or perform embodiments and/or processes described herein. For example, the computing system 500, when configured as part of an elevator control system, is used to receive commands and/or instructions and is configured to control operation of an elevator car through control of an elevator machine. For example, the computing system 500 can be integrated into or separate from (but in communication therewith) an elevator controller and/or elevator machine and operate as a portion of elevator sensor system 220 of FIG. 2.

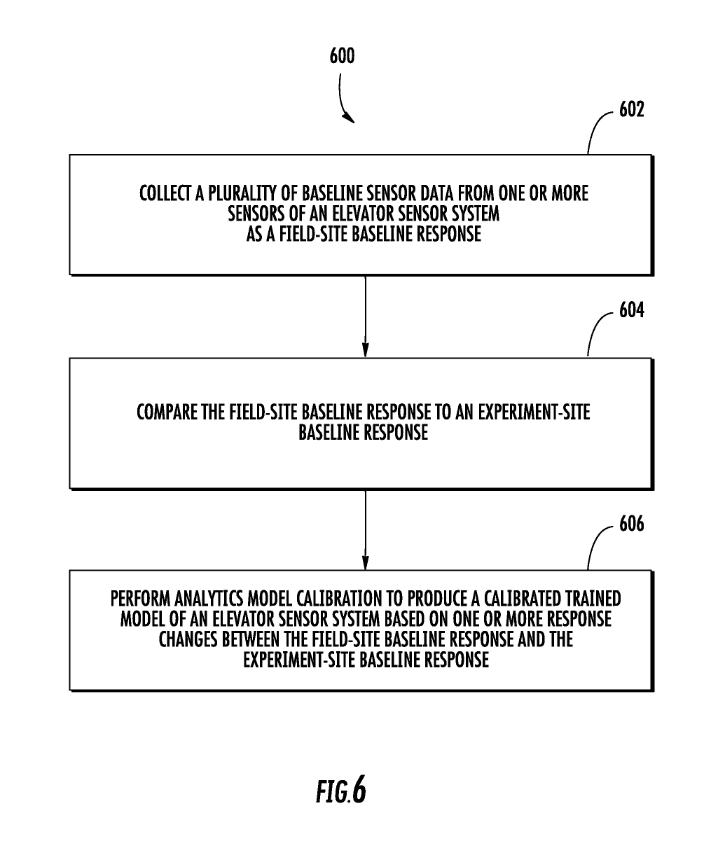

The computing system 500 is configured to operate and/or control calibration of the elevator sensor system 220 of FIG. 2 using, for example, a flow process 600 of FIG. 6. The flow process 600 can be performed by a computing system 500 of the elevator sensor system 220 of FIG. 2 as shown and described herein and/or by variations thereon. Various aspects of the flow process 600 can be carried out using one or more sensors, one or more processors, and/or one or more machines and/or controllers. For example, some aspects of the flow process involve sensors, as described above, in communication with a processor or other control device and transmit detection information thereto. The flow process 600 is described in reference to FIGS. 1-6.

At block 602, a computing system 500 of the elevator sensor system 220 collects a plurality of baseline sensor data (e.g., sensor data 402) from one or more sensors 214 of elevator sensor system 220 as a field-site baseline response 324. Collection of the baseline sensor data can be performed responsive to a calibration mode request and/or otherwise be performed during normal operation of the elevator door 204 when embodied in an elevator door system. In some embodiments, the baseline sensor data can be collected at two or more different landings 125 of elevator system 101, e.g., to perform floor-level specific calibration of the elevator sensor system 220.

At block 604, the computing system 500 compares the field-site baseline response 324 to an experiment-site baseline response 304. One or more response changes between the field-site baseline response 324 and the experiment-site baseline response 304 can be characterized based on feature data extracted from sensor data 402 using feature extraction 405 in comparison to features 406 extracted from the experiment-site baseline response 304.

At block 606, the computing system 500 performs analytics model calibration 410 to produce the calibrated trained model 404 based on one or more response changes between the field-site baseline response 324 and the experiment-site baseline response 304. Transfer learning can be applied to determine a transfer function 336 based on the one or more response changes. A baseline designation 330 of the calibrated trained model 404 can be shifted according to the transfer function 336. Transfer learning can shift at least one trained classification model, at least one trained regression model, and/or at least one trained fault detection model. The fault designation 332 can include one or more of: a roller fault, a track fault, a sill fault, a door lock fault, a belt tension fault, a car door fault, a hall door fault and/or other known fault types associated with the elevator door assembly 130. When implemented with respect to other systems of the elevator system 101, calibration for prognostic and diagnostic monitoring can include sensors 214 for one or more of: monitoring elevator motion, door motion, position referencing, leveling, environmental conditions, and/or other detectable conditions.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., an apparatus or system) to perform one or more methodological acts as described herein.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method comprising:
collecting, by a computing system, a plurality of baseline sensor data from one or more sensors of an elevator sensor system as a field-site baseline response;
comparing, by the computing system, the field-site baseline response to an experiment-site baseline response; and
performing, by the computing system, analytics model calibration to produce a calibrated trained model for fault diagnostics and/or prognostics based on one or more response changes between the field-site baseline response and the experiment-site baseline response.

2. The method of claim 1, wherein the calibrated trained model is trained by performing a plurality of experiments on a different instance of the elevator sensor system, including an experiment baseline that generates the experiment-site baseline response.

3. The method of claim 1, wherein performing analytics model calibration comprises applying transfer learning to determine a transfer function based on the one or more response changes.

4. The method of claim 3, wherein a baseline designation of the calibrated trained model is shifted according to the transfer function.

5. The method of claim 3, wherein transfer learning shifts at least one trained classification model.

6. The method of claim 3, wherein transfer learning shifts at least one trained regression model.

7. The method of claim 6, wherein transfer learning shifts at least one trained fault detection model, and a fault designation comprises one or more of: a roller fault, a track fault, a sill fault, a door lock fault, a belt tension fault, a car door fault, and a hall door fault.

8. The method of claim 1, wherein collection of the baseline sensor data is performed responsive to a calibration mode request.

9. The method of claim 1, wherein collection of the baseline sensor data is performed during normal operation of an elevator door.

10. The method of claim 1, wherein the baseline sensor data is collected at two or more different landings of an elevator system.

11. An elevator sensor system comprising:
one or more sensors operable to monitor an elevator system; and
a computing system comprising a memory and a processor that collects a plurality of baseline sensor data from the one or more sensors as a field-site baseline response, compares the field-site baseline response to an experiment-site baseline response, and performs analytics model calibration to produce a calibrated trained model for fault diagnostics and/or prognostics based on one or more response changes between the field-site baseline response and the experiment-site baseline response.

12. The elevator sensor system of claim 11, wherein the calibrated trained model is trained by performing a plurality of experiments on a different instance of the elevator sensor system, including an experiment baseline that generates the experiment-site baseline response.

13. The elevator sensor system of claim 11, wherein performance of analytics model calibration comprises applying transfer learning to determine a transfer function based on the one or more response changes.

14. The elevator sensor system of claim 13, wherein a baseline designation of the calibrated trained model is shifted according to the transfer function.

15. The elevator sensor system of claim 13, wherein transfer learning shifts at least one trained classification model.

16. The elevator sensor system of claim 13, wherein transfer learning shifts at least one trained regression model.

17. The elevator sensor system of claim 16, wherein transfer learning shifts at least one trained fault detection model, and a fault designation comprises one or more of: a roller fault, a track fault, a sill fault, a door lock fault, a belt tension fault, a car door fault, and a hall door fault.

18. The elevator sensor system of claim 11, wherein collection of the baseline sensor data is performed responsive to a calibration mode request.

19. The elevator sensor system of claim 11, wherein collection of the baseline sensor data is performed during normal operation of an elevator door.

20. The elevator sensor system of claim 11, wherein the baseline sensor data is collected at two or more different landings of an elevator system.
